(19) United States
(12) Patent Application Publication
(10) Pub. No.: US 2025/0149871 A1
(43) Pub. Date: May 8, 2025

(54) ADJUSTABLE ELECTRICAL BOX WITH IMPROVED STABILITY

(71) Applicant: ERICO International Corporation, Solon, OH (US)

(72) Inventor: Michael Hung-Sun Oh, Twinsburg, OH (US)

(21) Appl. No.: 18/942,049

(22) Filed: Nov. 8, 2024

Related U.S. Application Data
(60) Provisional application No. 63/597,085, filed on Nov. 8, 2023.

(51) Int. Cl. H02G 3/08; H02G 3/14; H02G 3/16

(52) U.S. Cl. CPC H02G 3/086; H02G 3/081; H02G 3/14; H02G 3/16

(57) ABSTRACT

An assembly for an adjustable-depth electrical box can include an outer box and an inner box slidably received into the outer box. The outer box can include outer sidewalls extending from a base end to an open end of the outer box. The inner box can include inner sidewalls and guide protrusions. The inner sidewalls can include a first set of opposed inner sidewalls and a second set of opposed inner sidewalls, and the guide protrusions can include at least one guide protrusion, respectively, on each inner sidewall of the first set of opposed inner sidewalls and on each inner sidewall of the second set of opposed inner sidewalls.

### CROSS-REFERENCE TO RELATED APPLICATIONS

This application claims the benefit of U.S. Provisional Patent Application No. 63/597,085, filed Nov. 8, 2023, which is incorporated herein by reference in its entirety.

### BACKGROUND

In many applications, it may be useful to support electrical boxes at different depths relative to support structures, including ceiling or wall structures of buildings.

### SUMMARY

Some embodiments of the invention provide an adjustable-height electrical box that includes an outer box and an inner box. The outer box may include outer sidewalls that may extend from a base end to an open end of the outer box. The outer sidewalls may include a first outer sidewall, a second outer sidewall opposite the first outer sidewall, a third outer sidewall, and a fourth outer sidewall opposite the third outer sidewall. The inner box may include inner sidewalls extending between a first end and a second end of the inner box, including a first inner sidewall, a second inner sidewall opposite the first inner sidewall, a third inner sidewall, and a fourth inner sidewall opposite the third inner sidewall. The inner box may also include guide protrusions extending outwardly from the inner sidewalls, including a first guide protrusion protruding from the first inner sidewall, a second guide protrusion protruding from the second inner sidewall, a third guide protrusion protruding from the third inner sidewall, and a fourth guide protrusion protruding from the fourth inner sidewall. The outer sidewalls may slidably receive the inner box with the first guide protrusion contacting an inner side of the first outer sidewall, the second guide protrusion contacting an inner side of the second outer sidewall, the third guide protrusion contacting an inner side of the third outer sidewall, and the fourth guide protrusion contacting an inner side of the fourth outer sidewall to guide sliding movement of the inner box relative to the outer box.

Some embodiments of the invention provide an adjustable-height electrical box that includes an outer box and an inner box. The outer box may include outer sidewalls extending from a base end to an open end of the outer box. The inner box may be slidably received into the outer box and may include sidewalls extending between a first free edge and a second free edge of the inner box, including a first set of opposed inner sidewalls and a second set of opposed inner sidewalls. The inner box may include guide protrusions extending from the inner sidewalls to engage the outer sidewalls. The guide protrusions may include at least one guide protrusion, respectively, on each inner sidewall of the first set of opposed inner sidewalls and on each inner sidewall of the second set of opposed inner sidewalls.

Some embodiments of the invention provide a method of assembling an adjustable-depth electrical box. In some embodiments, the method may include aligning an inner box relative to an outer box so that guide protrusions on at least four inner sidewalls of the inner box may engage corresponding at least four outer sidewalls of the outer box. The method may include inserting the inner box into the outer box to engage the guide protrusions with the at least four outer sidewalls. The method may include, with the guide protrusions engaged with the at least four outer sidewalls, adjusting a depth of the inner box relative to the outer box.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of an electrical box assembly in a first position according to an embodiment of the invention;

FIG. 2 is a first perspective view of an outer box of the electrical box assembly of FIG. 1;

FIG. 3 is a second perspective view of the outer box of the electrical box assembly of FIG. 1;

FIG. 4 is a perspective view of an inner box of the electrical box assembly of FIG. 1;

FIG. 5A is a front elevation view of the inner box of the electrical box assembly of FIG. 1;

FIG. 5B is an enlarged view of the inner box of FIG. 5A, taken at area VB-VB of FIG. 5A;

FIG. 6 is a front elevation view of the electrical box assembly of FIG. 1;

FIG. 7 is a perspective view of the electrical box assembly of FIG. 1 in a second position;

FIG. 8 is a cross-sectional view of the electrical box assembly of FIG. 1, taken at VIII-VIII of FIG. 6;

FIG. 9 is a perspective view of an electrical box assembly in a first position according to an embodiment of the invention;

FIG. 10 is a front elevation view of the electrical box assembly of FIG. 9;

FIG. 11 is a perspective view of the electrical box assembly of FIG. 9 in a second position;

FIG. 12 is a cross-sectional view of the electrical box assembly of FIG. 9, taken at XII-XII of FIG. 10;

FIG. 13 is a front elevation view of an electrical box assembly according to an embodiment of the invention;

FIG. 14 is a front elevation view of an electrical box assembly according to an embodiment of the invention;

FIG. 15 is a front elevation view of an electrical box assembly according to an embodiment of the invention;

FIG. 16 is a front elevation view of an electrical box assembly according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to support electrical boxes at different depths relative to relevant building structures. In this regard, an electrical box having an adjustable extension may provide flexibility for installers. For example, in some installations an electrical box assembly may need to be arranged with a front opening of an electrical box flush with an exterior surface of a wall or ceiling structure (e.g., drywall, tile, etc.) However, other portions of an electrical box assembly may need to be engaged with a building support structure (e.g., a stud, support bracket, ceiling structure, etc.) at a depth that can vary between different sites or installations. Further in this regard, it can sometimes be difficult to precisely space a support structure relative to the relevant surfaces of drywall or ceiling tile. For example, the relevant support structure may be offset from the interior surface of the drywall or ceiling at an undesirable distance (e.g., too far away). It may accordingly be beneficial to install an adjustable electrical box having an adjustably extendable component, so as to be able to selectively extend or retract the extendable component of the electrical box to comply with relevant spacing (or other) requirements.

Correspondingly, embodiments of the invention can provide an electrical box and associated assembly or method that can allow easy adjustment of an extension of an electrical box relative to a support structure, including after the electrical box has been installed on the support structure. Examples of the present invention may accordingly save time and money during installation and provide for improved service configurations, including by allowing installers to simply adjust the extension of the electrical box itself to accommodate the needs of a particular installation.

Generally, embodiments of the invention can include an electrical box assembly configured to support electrical components (e.g., light fixtures, low voltage devices, or other known electrical devices, etc.). The electrical box assembly may be secured to one or more other structures directly or indirectly, including in various in-wall and overhead applications (e.g., with direct mounting to studs or ceiling, or with indirect mounting via brackets supports on studs or T-grid ceiling members). The electrical box assembly may include an adjustable front extension, configured to be adjusted to be flush with a visible surface in a building (e.g., wall or ceiling surfaces of various types, including drywall and ceiling tiles, etc.).

Thus, some examples can be flexibly used with support structures that have a wide range of distances from a relevant surface (e.g., drywall or ceiling tile having various different thicknesses). In this regard, unless otherwise noted or required, the term “height” is used herein to refer to a direction of adjustment for an extendable electrical box assembly, which is generally in a direction that extends perpendicularly between a back of an electrical box and a front of an electrical box, and may not necessarily correspond to a vertical direction for a particular installation.

The electrical box assembly may include an outer box and an inner box nested within the outer box. The inner box may be configured to be translationally adjusted relative to the outer box along an axis that is transverse to the base of the outer box. Further, the inner box may include multiple protrusions from sidewalls of the inner box, to guide movement of the inner box relative to the outer box.

As well as generally guiding movement, the noted protrusions on an adjustable electrical box can help to avoid unwanted movement of an inner box relative to an outer box. For example, in designs with relatively large clearance between inner and outer boxes, the inner box may exhibit a degree of wobble relative to the outer box (e.g., partial rotation about multiple axes). Inclusion of protrusions as disclosed herein can help to reduce this movement and thereby allow for more secure support of light fixtures or other electrical devices supported by the box.

In some embodiments, the inner box may include guide protrusions disposed in a pattern around the inner box to provide optimally robust support without compromising adjustability (e.g., as may result from friction between adjacent box walls). In some embodiments, one of the guide protrusions may be disposed adjacent each junction that joins the one or more inner sidewalls. In some embodiments, multiple opposed sets of sidewalls may include guide protrusions (e.g., each of at least four inner sidewalls may include at least one guide protrusion).

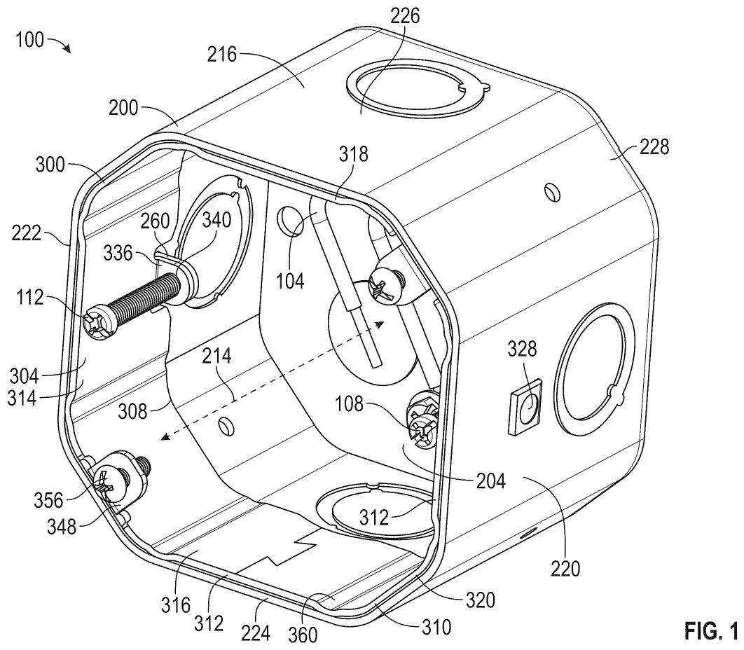

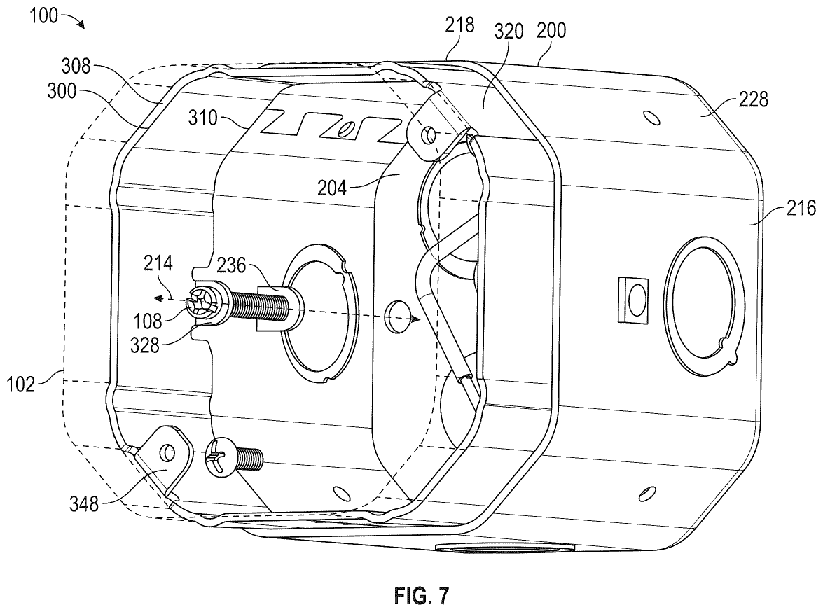

FIG. 1. illustrates an example electrical box assembly 100 according to an embodiment of the invention. The electrical box assembly 100 may be secured to a support structure (e.g., ceiling structure, or an on- or between-stud bracket of various known types (not shown)). The electrical box assembly 100 may be used to suspend one or more electrical components 102 (e.g., luminaire light fixtures, low voltage devices, mudrings or other electrical devices of various known types (as shown in FIG. 7)), from the support structure (e.g., studs, ceiling members, or brackets of various known configurations). In some examples, the electrical components 102 may include more than one component, including with one or more electrical devices coupled to the electrical box assembly 100 via a mudring. The electrical box assembly 100 may further house one or more conductors (not shown), arranged for electrical connection to the relevant electrical devices. In some embodiments, the assembly 100 may include a ground wire 104.

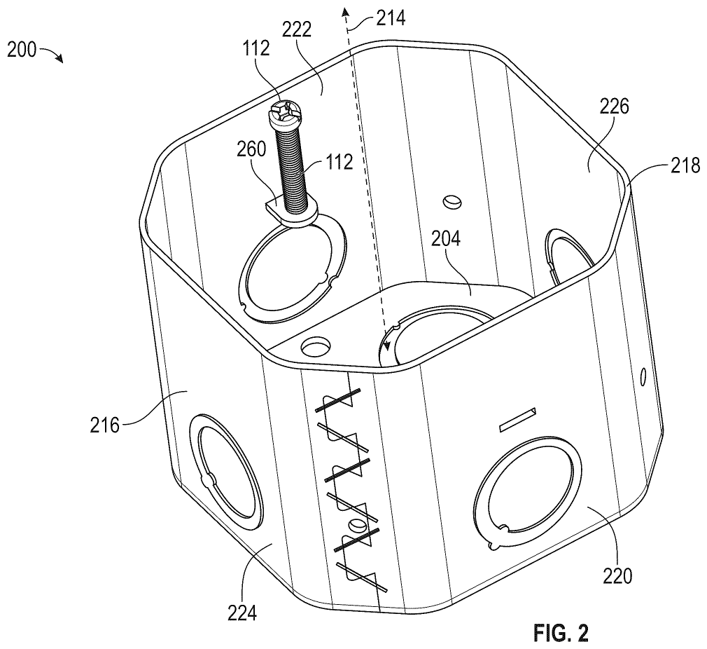

Referring to FIGS. 1-3, the electrical box assembly 100 may include an outer box 200. The outer box 200 may include a base 204. In the illustrated embodiment, the base 204 is octagonal, however the base 204 may be any shape (e.g., square, rectangular, circular, etc.). In some embodiments, the outer box 200 may include a center axis 214 that extends substantially perpendicular from a center of the base 204 (see FIG. 1).

A plurality of outer sidewalls 216 may extend from the base 204, toward an open end 218. The outer sidewalls 216 may extend from a perimeter of the base 204. A perimeter of the outer sidewalls 216 may therefore be the same shape as the base 204. The outer sidewalls 216 may be fastened to the base 204 via fasteners, spot welding, rivets, or other known fastening mechanisms. As described further below, the base 204 may be fastened to the outer sidewalls 216 as a last (or other) step of assembling the electrical box assembly 100. In some embodiments, the outer sidewalls 216 may extend substantially parallel or axially to the center axis 214. In some embodiments, the outer sidewalls 216 may be cold formed (e.g., stamped). In some embodiments, the outer sidewalls 216 may be cold formed from a single sheet of metal. In some embodiments, the outer sidewalls 216 may instead be formed by deep drawing processes.

In some embodiments, the outer box 200 may include a first outer sidewall 220, a second outer sidewall 222, a third outer sidewall 224, and a fourth outer sidewall 226. The first outer sidewall 220 may be substantially parallel to the second outer sidewall 222. The third outer sidewall 224 may be substantially parallel to the fourth outer sidewall 226. In some embodiments, the first outer sidewall 220 and the second outer sidewall 222 may be substantially perpendicular to the third outer sidewall 224 and the fourth outer sidewall 226. In some embodiments, the outer box 200 may include fewer or more of the outer sidewalls 216. For example, as illustrated in FIG. 1, the outer box 200 may include a plurality of outer junctions 228 (e.g., outer junction walls or corners) that join adjacent walls of the outer sidewalls 220, 222, 224, 226. Further, in some examples, the outer box 200 may include side walls but not a base wall (e.g., may be an open-backed structure).

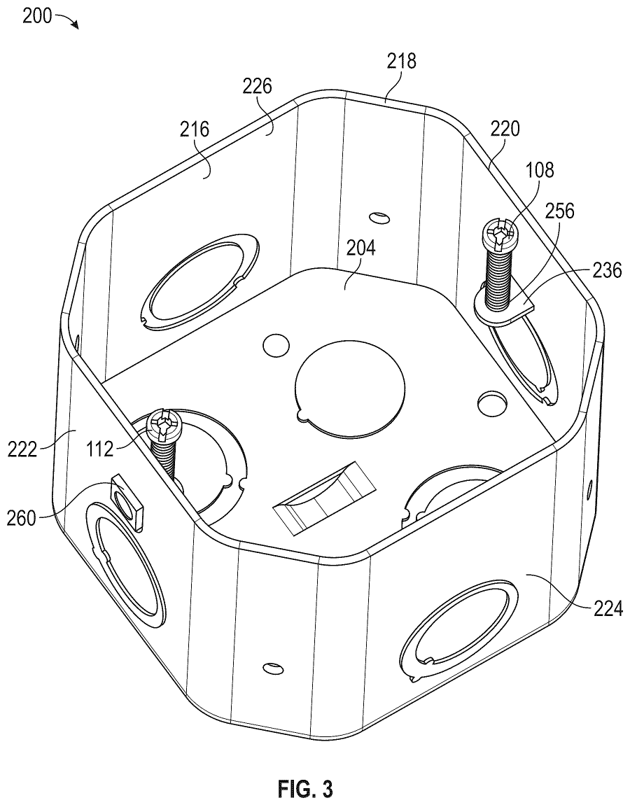

Still referring to FIGS. 1-3, in some embodiments, the outer sidewalls 216 may include various structures to allow height adjustment. For example, the first outer sidewall 220 may include an inwardly extending first outer tab 236 with a first outer aperture 256 (see FIG. 3). The first outer aperture 256 may be configured to receive a first tab fastener 108 for height adjustment, as further discussed below. In some embodiments, an inwardly extending second outer tab 260, having a second outer aperture 264, may be similarly extend from a second outer sidewall 222 to receive a second tab fastener 112. In some embodiments, the first outer tab 236 may be directly opposite the second outer tab 260. In some embodiments, the outer sidewalls 216 may include more or fewer outer tabs. As described further below, rotation of the first tab fastener 108 or the second tab fastener 112 may alter a height of the electrical box assembly 100.

Still referring to FIGS. 1-3, the outer tabs 236, 260 may be fastened to the first and second outer sidewalls 220, 222 via spotwelding or riveting, or may instead be integrally formed (e.g., stamped) from the first and second outer sidewalls 220, 222. In some embodiments, the outer tabs 236, 260 may be spot welded or riveted to an internal surface of the first and second outer sidewalls 220, 222. In some embodiments, the outer tabs 236, 260 may be spot welded or riveted to an external surface of the first and second outer sidewalls 220, 222, and the outer tabs 236, 260 may extend through apertures in the first and second outer sidewalls 220, 222, to an internal volume of the outer box 200. In some examples, stamping the outer tabs 236, 264 from the first and second outer sidewalls 220, 222 may result in holes in the first and second outer sidewalls 220, 222, which may be covered by a plate that is spotwelded or otherwise fastened to the sidewalls 220, 222.

Referring to FIGS. 1, 4, and 5, the electrical box assembly 100 may also include an inner box 300. The inner box 300 may include a plurality of inner sidewalls 304 that extend from a first end to a second end. For example, as shown, the sidewalls 304 may extend from a first free edge at free end 308 to a second free edge at free end 310 to define a sleeve with no base or back wall (or front wall). In some embodiments, a perimeter of the inner sidewalls 304 may be shaped liked a octagon, square, rectangle, circle, or any other shape. In some embodiments, the perimeter of the inner sidewalls 304 may be shaped like the perimeter of the outer sidewalls 216, but with slightly smaller overall dimensions. In some embodiments, the inner sidewalls 304 may be cold formed (e.g., stamped). In some embodiments, the inner sidewalls 304 may be cold formed from a single sheet of metal.

In some embodiments, the inner box 300 may include a first inner sidewall 312, a second inner sidewall 314, a third inner sidewall 316, and a fourth inner sidewall 318. The first inner sidewall 312 may be substantially parallel to the second inner sidewall 314. The third inner sidewall 316 may be substantially parallel to the fourth inner sidewall 318. In some embodiments, the first inner sidewall 312 and the second inner sidewall 314 may be substantially perpendicular to the third inner sidewall 316 and the fourth inner sidewall 318. In some embodiments, the inner box 300 may include fewer or more of the inner sidewalls 304. For example, as illustrated in FIG. 1, the inner box 300 may include a plurality of inner junctions 320 (e.g., inner junction walls or corners) that join adjacent walls of the inner sidewalls 312, 314, 316, 318.

Still referring to FIGS. 1, 4, and 5, in some embodiments, the inner sidewalls 318 may include various structures to allow height adjustment. For example, in some embodiments, the inner sidewalls 304 may also include one or more inner tabs that extend toward a center of the inner box 300. In some embodiments, the one or more inner tabs may be disposed proximate the first free end 308 (e.g., extend integrally from the inner sidewalls 304 at the first free end 308). In one example, the first inner sidewall 312 may include an inwardly extending first inner tab 328. The first inner tab 328 may include a first inner aperture 332. The first inner aperture 332 may be threaded, configured to receive the first tab fastener 108. In some embodiments, a second inner tab 336, having a second inner aperture 340, may also extend inwardly from the second inner sidewall 314. The second inner aperture 340 may be threaded, configured to receive the second tab fastener 112. In some embodiments, the first inner tab 328 may be directly opposite the second inner tab 336. In some embodiments, the inner sidewalls 304 may include more or few inner tabs.

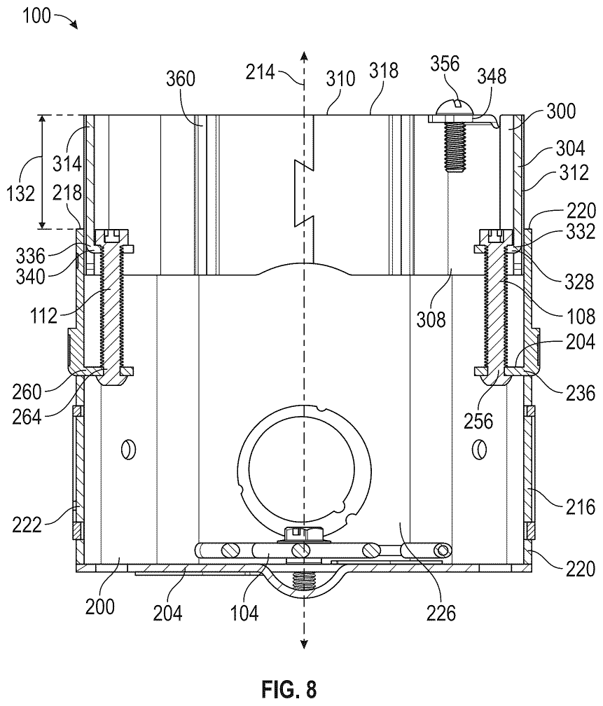

As illustrated in FIG. 8, generally, the inner tabs 328, 336 can be aligned with the outer tabs 236, 260 to allow adjustment of a position of the inner box 300 relative to the outer box 200 (e.g., in parallel with the center axis 214). Specifically, a first set of aligned tabs including the first inner tab 328 and the first outer tabs 236 can cooperatively receive the first tab fastener 108, and a second set of aligned tabs including the second inner tab 336 and the second outer tabs 260 can cooperatively receive the second tab fastener 112. In the illustrated embodiment, rotation of the first tab fastener 108 may cause the first inner tab 328, and therefore the inner box 300, to be translated along a threaded portion of the fastener 108 (e.g., relative to the outer box 200). Similarly, rotation of the second tab fastener 112 may cause the second inner tab 332, and therefore the inner box 300, to be translated along a threaded portion of the fastener 112. In some examples both the first tab fastener 108 and the second tab fastener 112 may be rotated to cooperatively translate the inner box 300 relative to the outer box 200.

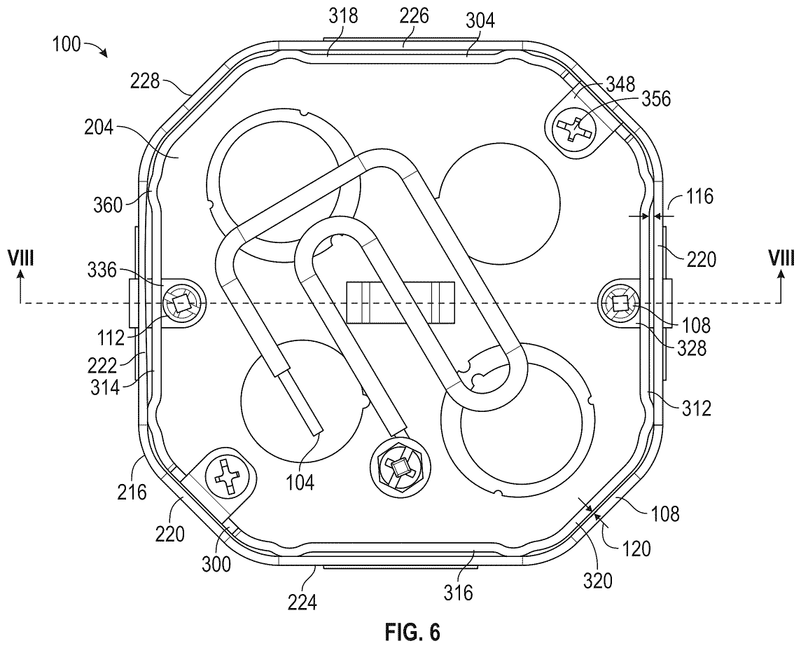

Referring again to FIGS. 1 and 6, in some embodiments, the inner sidewalls 304 may include one or more mounting tabs 348 that can be used in combination with fasteners 356 to attach the other components 102 to the inner box 300 (e.g., to attach luminaire light fixtures of various known types). In some examples, the mounting tabs 348 may be positioned around the inner box 300 to mount and install the components 102 that have industry standard mounting locations.

To guide height adjustment of the electrical box assembly 100 and prevent undesired movement of the inner box 300, the electrical box assembly (e.g., the inner box 300, as shown) may include a plurality of guide protrusions 360. The guide protrusions 360 may be spaced along the inner sidewalls 304 and may protrude outwardly from the inner sidewalls 304 (i.e., away from a center of the inner box 300 or the axis 214—see FIG. 1). As described in more detail below, the guide protrusions 360 may be configured to engage the outer sidewalls 216 during adjustment and service. Specifically, the guide protrusions 360 may slidably engage the outer sidewalls 216 to permit easy adjustment of the inner box 300 relative to the outer box 200.

In some examples, the guide protrusions 360 may provide the only direct contact points between the outer box 200 and the inner box 300. For example, the guide protrusions 360 may provide a clearance 116 (e.g., a gap) between one or more of the inner sidewalls 304 and a respective one of the outer sidewalls 216. In some examples, the guide protrusions 360 may further provide a clearance 120 between one or more of the inner junctions 320 and a respective one of the outer junctions 228. In some examples, the clearances 116, 120 may be at least about 0.05 inches, at least about 0.035 inches, or at least about 0.03 inches, or at least about 0.025 inches, or at least about 0.02 inches. In some examples, the clearances 116, 120 may be different. In some examples, mitigating the points of contact between the outer box 200 and the inner box 300 may advantageously reduce frictional forces counteracting the movement of the inner box 300 during adjustment, while also reducing the likelihood that the inner box 300 becomes stuck during adjustment. Furthermore, in some configurations, a relatively narrow clearance may further reduce the ability of the inner box 300 to move in undesirable ways relative to the outer box 200.

Generally, it may be beneficial for multiple sets of opposed sides of an electrical box to include guide protrusions. Thus, for example, the inner box 300 can include the guide protrusions 360 on the first inner sidewall 312 and the second inner sidewall 314 and on the third inner sidewall 316 and the fourth inner sidewall 318. In some embodiments, more than one of the guide protrusions 360 may be disposed on the first, second, third, or fourth inner sidewalls 312, 314, 316, 318. For example, each of the first, second, third, or fourth inner sidewalls 312, 314, 316, 318 may have two or more of the guide protrusions 360. In some embodiments, the guide protrusions 360 may be disposed around the inner box 300 in a symmetrical pattern or may be arranged in sets of opposed pairs of protrusions.

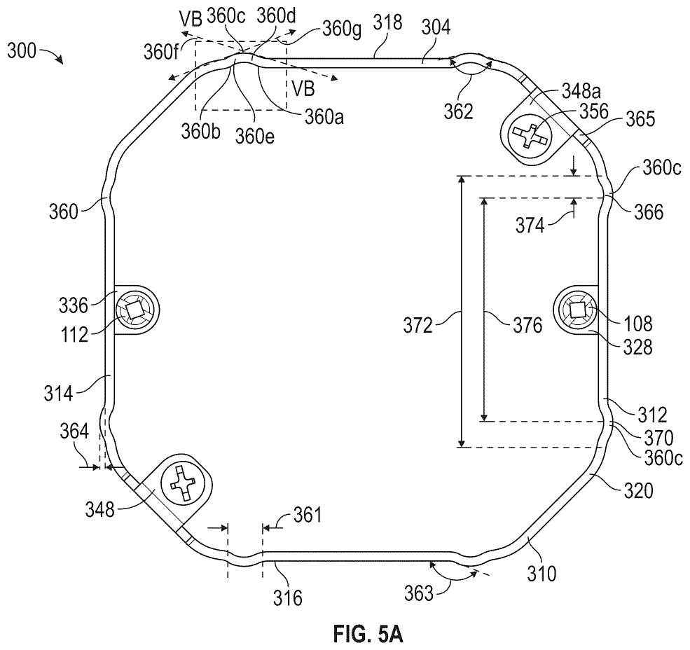

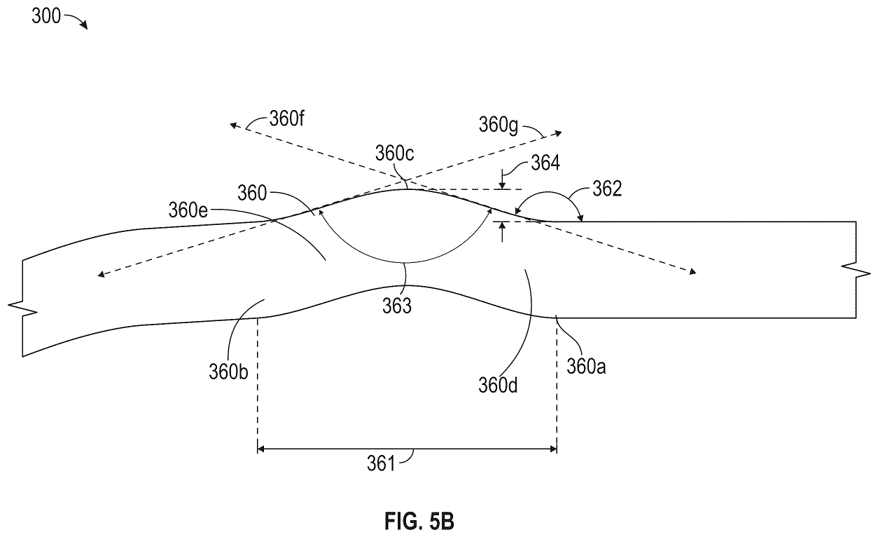

Referring to FIGS. 5A and 5B, in some examples, the guide protrusions 360 may extend along one of the inner sidewalls 304 from a respective first protrusion end 360a and a respective second protrusion end 360b. Specifically, the guide protrusions 360 may deflect from a respective one of the inner sidewalls 304 at the first protrusion end 360a and at the second protrusion end 360b Additionally, the guide protrusions 360 may include a peak 360c disposed between the first protrusion end 360a and the second protrusion end 360b. For example, the peaks 360c may be disposed at a midway point between each of the first protrusion ends 360a and the second protrusion ends 360b. Furthermore, in some examples, the guide protrusions 360 may include a first protrusion section 360d extending between the first protrusion end 360a and the peak 360c, and may also include a second protrusion section 360e extending between the second protrusion end 360b and the peak 360c. In some examples, the peaks 360c of the guide protrusions 360 may define the only points of contact between the inner box 300 and the outer box 200.

Referring specifically to FIG. 5B, in some examples, the guide protrusions 360 may define a guide protrusion width 361, measured along a width direction in parallel with the side wall from which the particular protrusion 360 deviates. The guide protrusion width 361 of the guide protrusions 360 may be measured between a respective one of the first protrusion ends 360a and a respective one of the second protrusion ends 360b. In some embodiments, the guide protrusion width 361 may be at least about, 0.10 inches, at least about 0.15 inches, at least about 0.20 inches, at least about 0.25 inches. In some examples, the guide protrusions 361 that define a larger width may be easier to manufacture or may result in fewer manufacturing defects. Furthermore, in some examples, the guide protrusions 360 that define a larger width may define a wider peak, resulting in a greater contact area between the inner box 300 and the outer box 200, thus advantageously providing better stabilization.

In some examples, the guide protrusion width 361 of the guide protrusions 360 may be selected in combination with a first protrusion angle 362 measured between the first protrusion section 360d of the guide protrusions 360 and a respective one of the inner sidewalls 304. For example, the first protrusion angle 362 may be measured between a first tangent axis 360f, that extends tangentially from the guide protrusions 360 at a midpoint along the guide protrusions 360 between the first protrusion end 360a and the peak 360c, and a respective one of the inner sidewalls 304 (e.g., the width direction described above). In some examples, the first protrusion angle 362 may be at least about 140 degrees, or may be at least about 150 degrees, may be at least about 155 degrees. In some examples, the guide protrusions 360 defining a larger first protrusion angle 362 may define a larger width and may thus provide the manufacturing and use advantages listed in the paragraph above, as well as provide improved resilient response of the various protrusions (e.g., for smoother depth adjustment).

In some examples, the guide protrusion width 361 of the guide protrusions 360 may be selected in combination with an angle that is defined between the first protrusion section 360d and the second protrusion section 360e of the guide protrusions 360. For example, a second protrusion angle 363 may be measured between the first tangent axis 360f, and a second tangent axis 360g that extends tangentially from the guide protrusions 360 at a midpoint along the guide protrusions 360 between the second protrusion end 360b and the peak 360c. In some examples, the second protrusion angle 363 may be at least about 130 degrees, at least about 135 degrees, 140 degrees, or may be at least about 150 degrees, or may be at least about 155 degrees. In some examples, the guide protrusions 360 defining a larger second protrusion angle 363 may define a larger width and may thus provide the manufacturing and use advantages listed in the paragraphs above, as well as provide improved resilient response of the various protrusions (e.g., for smoother depth adjustment).

In some examples, for the guide protrusions 360 that include the guide protrusion width 361 of at least 0.2 inches, synergistic effects may result from the first protrusion angle 362 being at least 150 degrees, and the second protrusion angle 363 being at least 135 degrees. For example, this particular combination may increase a contact surface area between the guide protrusions 360 and the outer sidewalls 216, while also providing advantageous deformation characteristics of the guide protrusions 360 (e.g., to allow easier adjustment of the inner box 300 relative to the outer box 200, and avoidance of binding).

In some embodiments, the peak 360c of the guide protrusions 360 may define a maximum extension of guide protrusions 360. Specifically, the peak 360c of the guide protrusions 360 may define a furthest point of extension between the guide protrusions 360 and a respective one of the inner sidewalls 304. Referring still to FIG. 5B, in some embodiments, the guide protrusions 360 may extend a distance 364 that is about 0.034 inches from the inner sidewalls 304. In some embodiments, the distance 364 may be measured between the peak 360c of one of the guide protrusions 360 and an exterior surface a respective one of the inner sidewalls 304. In some embodiments, the guide protrusions 360 may extend the distance 364 that is between about 0.015 inches and about 0.050 inches from the inner sidewalls 304. In some embodiments, the guide protrusions 360 may extend the distance 364 that is between about 0.010 inches and about 0.045 inches from the inner sidewalls 304, or between about 0.015 inches and about 0.040 inches from the inner sidewalls 304, although manufacturing may be less reliable at distances of about 0.010 inches and smaller. Additionally, the inner box 300 may experience jam more frequently during adjustment relative to the outer box 200 when the distance 364 is less than 0.010. Furthermore, the inner box 300 may experience a greater amount of wobble or instability when the distance 364 is greater than 0.060. Generally, the guide protrusions 360 may all extend by a common distance from the relevant side wall, although other configurations are possible. For example, two or more of the guide protrusions 360 may extend dissimilar distances from the relevant side wall.

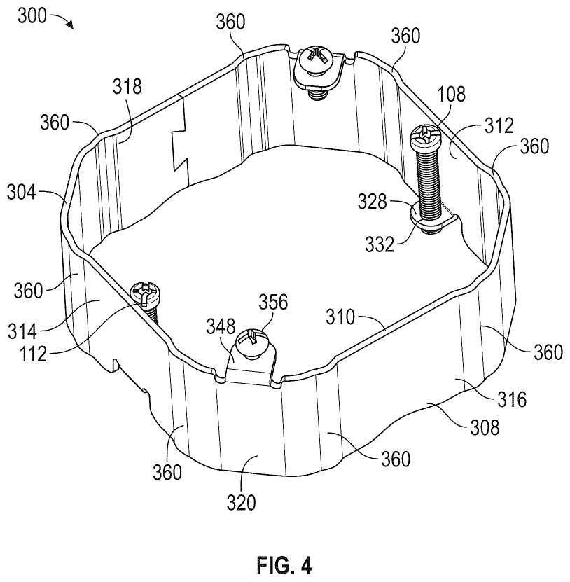

Referring to FIG. 4, in some embodiments, the guide protrusions 360 may extend along one of the inner sidewalls 304 over substantially all of a distance between the first free end 308 and the second free end 310 (i.e., may exhibit a total length that is substantially equal to the distance between the free ends 308, 310). For example, one or more of the guide protrusions 360 may be continuous from the first free end 308 to the second free end 310. In some examples, the guide protrusions 360 that continuous from the first free end 308 to the second free end 310 provide a greater contact area between the inner box 300 and the outer box 200, thus advantageously providing better stabilization.

In some embodiments, one or more of the guide protrusions 360 may be discontinuous from the first free end 308 to the second free end 310. For example, one or more of the guide protrusions 360, may not extend from the first free end 308 to the second free end 310, or one or more of the guide protrusions 360 may be divided into two or more subsections between the first free end 308 and the second free end 310. In some embodiments, one or more of the guide protrusions 360 may extend along the sidewalls 304 substantially perpendicular from an edge of the inner sidewalls 304 disposed at the second free end 310 or substantially in parallel with the axis 214 (see FIG. 1).

Referring again to FIG. 5A, in some embodiments, the guide protrusions 360 may be disposed adjacent to one of more of the inner wall junctions 320 that connect adjacent sets of the inner sidewalls 304. In some embodiments, a first guide protrusion 366 may be disposed adjacent a first inner junction 365, such that a bend line at one side of the first guide protrusion 366 intersects a bend line at a corresponding side of the first inner junction 365. Thus, for example, a curve of the first guide protrusion 366 may transition without offset into a curve of the first inner junction 365. In some embodiments, a bend line of the first guide protrusion 366 may instead be offset from a bend line of the first inner junction 365.

In some embodiments, the guide protrusions 360 may be spaced from the inner junctions 320 (e.g., not disposed on the inner junctions 320) to avoid potential interference with the mounting tabs 348 that may extend from one or more of the inner junctions 320. In some embodiments, a first tab 348a may extend from a first inner junction 365 between the first inner sidewall 312 and the fourth inner sidewall 318. Furthermore, in some examples, a first guide protrusion 366 of the first inner sidewall 312 may be disposed farther from the first inner junction 365 than the first tab 348a.

In some examples, the guide protrusions 360 may be spaced from the inner tabs 328, 336 and the inner junctions 320 to avoid potential interference with the inner tabs 328, 336 and the adjustment of the inner box 300 relative to the outer box 200. In some embodiments, the first guide protrusion 366 may be disposed between the first inner tab 328 and the first inner junction 365. Furthermore, in some embodiments, a second guide protrusion 370 may be disposed on the first inner sidewall 312 on a side of the first inner tab 328 that is opposite the first inner junction 365 (and the guide protrusion 366). Arranging the first and second guide protrusions 366, 370 on opposing sides of the first inner tab 328, and thus opposing sides of the first adjustment fastener 108, may provide smoother adjustment of the inner box 300 relative to the outer box 200 by balancing the points of contact between the inner box 300 and the outer box 200 about the first adjustment fastener 108.

As described above, the guide protrusions 360 may be disposed adjacent to the inner junctions 320. In some examples, the inner sidewalls 304 may define a first (full) sidewall length 372 measured between the first inner junction 365, and the inner junction 320 disposed between the first and second inner sidewalls 312, 318. Furthermore, a first distance 374 may be measured between the junction between the first inner junction 365 and the peak 360c of the first guide protrusion 366. In some examples, the first distance 374 may be between about 5% and about 15% of the first sidewall length 372. In some examples, the first distance 374 may be between about 1% and about 20% of the first sidewall length 372. Arranging the guide protrusions 360 near the junctions between the sidewalls 304 may advantageously provide increased stability to the inner box 200 during translation of the inner box 200 relative to the outer box 300, as well as after installation of the component 102 onto the inner box 300.

In some embodiments, a second guide protrusion 370 may be disposed on the first inner sidewall 312 on a side of the first inner tab 328 that is opposite the first inner junction 365 (and the guide protrusion 366). In some embodiments, a second distance 376 may be measured between the peak 360c of the first guide protrusion 366 and the peak 360c of the second guide protrusion 370 along the first sidewall 312. In some examples, the second distance 376 may be at least about 40% of the first sidewall length 372. In some examples, the second distance 376 may be at least about 50%, or at least about 60%, or at least about 70%, or at least about 75% of the first sidewall length 372. Spacing the guide protrusions 360 farther apart may advantageously provide increased stability to the inner box 300 during translation of the inner box 200 relative to the outer box 300, as well as after installation of the component 102 onto the inner box 300.

Generally, guide protrusions on inner boxes according to the disclosed technology can be arranged symmetrically relative to bisecting centerlines of the inner boxes (e.g., vertical and horizontal centerlines as viewed from a front of a box assembly). For example, the guide protrusions 360 disposed on the first inner sidewall 312 may be substantially equally spaced from the first inner tab 328. In some embodiments, the guide protrusions 360 on the first inner sidewall 312 may be substantially equally spaced from a center point of the first inner sidewall 312. Similarly, the second, third, and fourth inner sidewalls 314, 316, 318 may each include guide protrusions that are equally spaced from a respective center point of the second, third, and fourth inner sidewalls 314, 316, 318.

Referring to FIGS. 1, 6, 7, and 8, in order to assemble the electrical box 100, the inner box 300 may be inserted into the outer box 200, in an insertion direction that is substantially parallel to the center axis 214. Prior to insertion, the inner box 300 may be aligned relative to the outer box 200 so that guide protrusions 360 on the inner sidewalls 304 of the inner box 300 are aligned to engage the corresponding outer sidewalls 216 of the outer box 200. In some embodiments, the first free end 308 of the inner box 300 may be inserted first, so that the first free end 308 may be closer to the base 204 than the second free end 310. In some embodiments, the inner box 300 may be inserted such that the first inner sidewall 312 is adjacent the first outer sidewall 220. With the electrical box assembly 100 thus arranged, an extension height 132 of the electrical box assembly 100 may be measured from the open end 218 of the outer box 200 to the second free end 310 of the inner box 300. In some examples, for various types of boxes and installations, an extension height from an open end of an outer box can range from 0.0 inches to any of 0.875 inches, 0.950 inches or 1.500 inches.

As also noted above, the illustrated arrangement can align the first inner tab 328 with the first outer tab 236 so that rotation of the first tab fastener 108 may cause translational movement of the inner box 300 relative to the outer box 200 (e.g., in parallel with the axis 214) to vary the height 132 of the electrical box assembly 100. Similarly, the second tab fastener 112 may engage the second inner aperture 340 and the second outer aperture 264 so that rotation of the second tab fastener 112 can cause translational movement of the inner box 300, relative to the outer box 200.

Referring again to FIGS. 1, 6, 7, and 8, in some embodiments, the guide protrusions 360 disposed along the inner sidewalls 304 may engage an inner side of the outer sidewalls 216. For example, the guide protrusions 360 disposed on the first inner sidewall 312 may engage the first outer sidewall 220, the guide protrusions 360 disposed on the second inner sidewall 314 may engage the second outer sidewall 222, the guide protrusions 360 disposed on the third inner sidewall 316 may engage the third outer sidewall 224, and the guide protrusions 360 disposed on the fourth inner sidewall 318 may engage the fourth outer sidewall 226. Furthermore, in some examples, during the adjustment the inner box 300 relative to the outer box 200, the guide protrusions slidably engage the outer box 200 and act as the only direct contact points between the outer box 200 and inner box 300.

The guide protrusions 360 may thus frictionally engage the inner box 300 with (and within) the outer box 200 to guide height adjustment of the inner box 300 and reduce other movement of the inner box relative to the outer box 200 along other degrees of freedom. In particular, as also noted above, inclusion of multiple opposed sets of the guide protrusions may significantly reduce relative movement of the boxes 200, 300 in contrast to conventional designs. In some embodiments, as also generally noted above, the guide protrusions 360 are disposed symmetrically around the inner box 300, which may also significantly reduce unwanted relative movement of the boxes 200, 300 in contrast to conventional designs. A symmetrical arrangement may also provide smoother and more efficient translation of the inner 300 relative to the outer box 200 during height adjustment.

In some configurations, the base 204 of the outer box 200 may be coupled to the outer box 200 after the inner box 300 is assembled within the outer box 200. In such configurations, the fasteners 108, 112 may be riveted (or otherwise fastened) to the tabs 328, 336 through an open end of the outer box 200 (e.g., opposite the first free end 308 of the inner box 300) prior to the coupling of the base 204 to the outer box 200. The base 204 may then be coupled to the outer box 200 to close the open end. In other examples, the fasteners 108, 112 may be riveted (or otherwise fastened) to the tabs 328, 336 through a hole disposed in the base 204 after the base 204 is coupled to the outer box 200. In still other examples, the fasteners 108, 112 may be riveted (or otherwise fastened) to the tabs 328, 336 through the opening at the first free end 308 of the inner box 300.

In some configurations, the inner box 300 and the outer box 200 may be a galvanized metal (e.g., steel). Furthermore, the electrical box assembly 100 may be installed within buildings without additional coatings. In other configurations, the electrical box assembly 100 may be powder coated. In such configurations, the powder coating may be applied to the electrical box assembly 100 in stages. For example, exterior surfaces of the outer box 200 and the inner box 300, specifically the surfaces of the outer sidewalls 216 and inner sidewalls 304 that face away from the center axis 214, may be coated first. The inner box 300 may then be assembled within the outer box 300 and adjusted relative thereto to a desired extension or height. Interior surfaces of the outer box 200 and the inner box 300, specifically the surfaces of the outer sidewalls 216 and inner sidewalls 304 that face toward the center axis 214, may be coated after the height of the electrical box assembly 100 is adjusted. The interior surfaces of the outer box 200 and the inner box 300 may not be powder coated until after the height adjustment of the electrical box assembly 100, because the powder coating may lock the rotation of the adjustment fasteners 108, 112 relative to the tabs 328, 336, and thus the extension of the inner box 300 relative to the outer box 200.

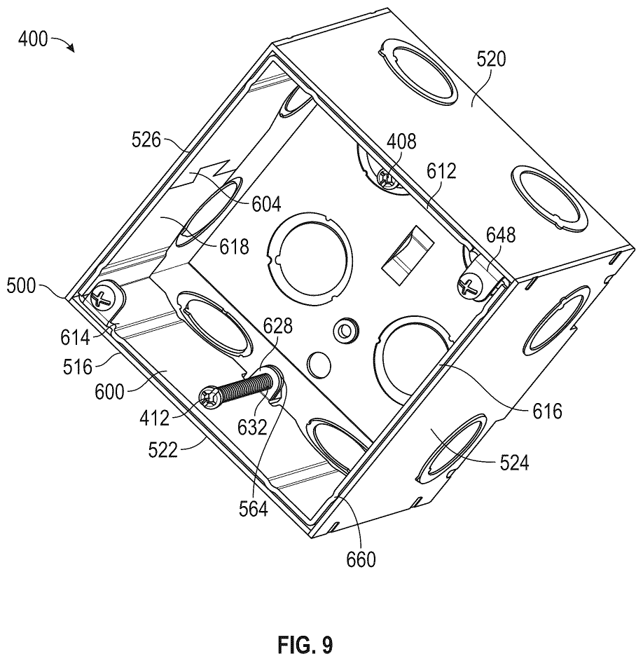

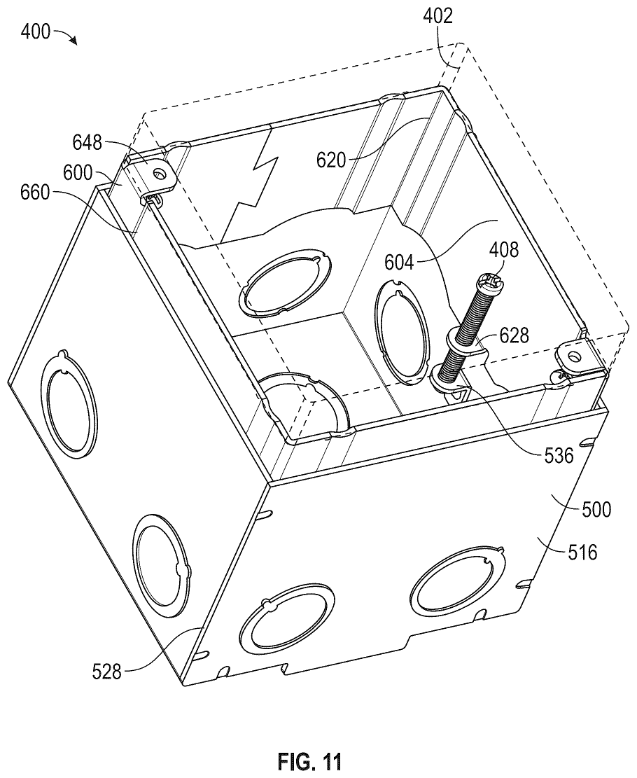

In some configurations, an electrical box assembly may include an alternate outer box or inner box configuration to accommodate other types of electrical components 402 (e.g., light fixtures, fire alarm fixtures, exit light fixtures, mudrings, or low-voltage devices) or other installation contexts. In this regard, for example, FIGS. 9-12 illustrate another embodiment of an electrical box assembly 400. The electrical box assembly 400 of FIGS. 9-12 may generally include similar features as the electrical box assembly 100 of FIGS. 1-8, including but not limited to an outer box 500, a plurality of outer sidewalls 516 (e.g., first, second, third, and fourth outer sidewalls 520, 522, 524, 526), outer junctions 528, a first and second outer tab 536, 560 having a first and second tab aperture 556 and 564 respectively, a first and second tab fastener 408, 412, an inner box 600, a plurality of inner sidewalls 604 (e.g., first, second, third, and fourth inner sidewalls 612, 614, 616, 618, the first sidewall 612 having a first (full) sidewall length 672), inner junctions 620 a first and second inner tab 628, 636 having first and second inner apertures 632 and 640 respectively, and one or more mounting tabs 648. Furthermore, the inner box 600 may include a plurality of guide protrusions 660 each having a guide protrusion width 661, a first guide protrusion angle 662, and a second guide protrusion angle 663, and the guide protrusions 660 may include a first guide protrusion 666 spaced from a first inner junction 665 by a first distance 674, and may further include a second guide protrusion 670 spaced from the first guide protrusion 666 by the second distance 676. Thus, discussion of the electrical box assembly 100 above also generally applies to similar components of the electrical box assembly 400 (and vice versa).

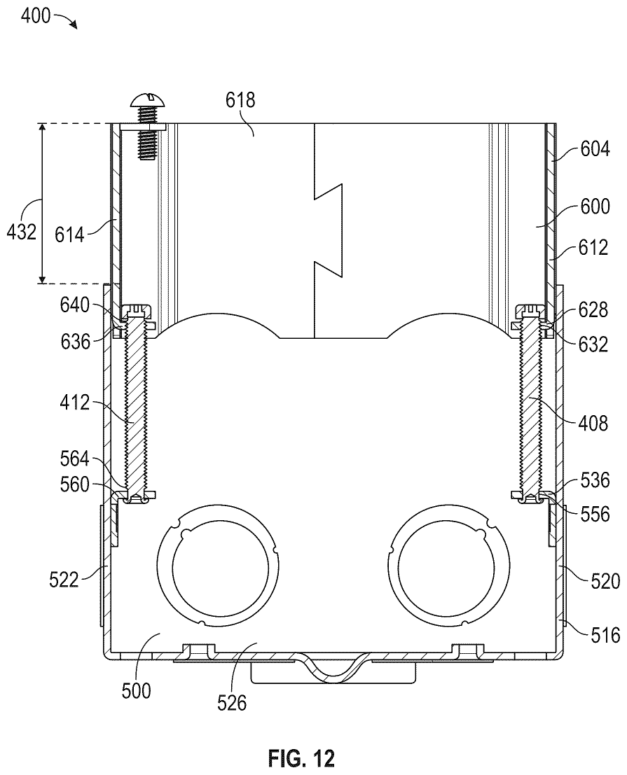

In some aspects, the electrical box assemblies 100 and 400 may differ. For example, the outer box 500 and the inner box 600 can have a rectangular (e.g., square) perimeter. Furthermore, in some embodiments, a height 432 of the electrical box assembly 400 (see FIG. 12) may differ from the height 132 of the electrical box assembly 100. As with the assembly 100, however, translational adjustment of the inner box 600 may potentially adjust the height 432 of the electrical box assembly 400.

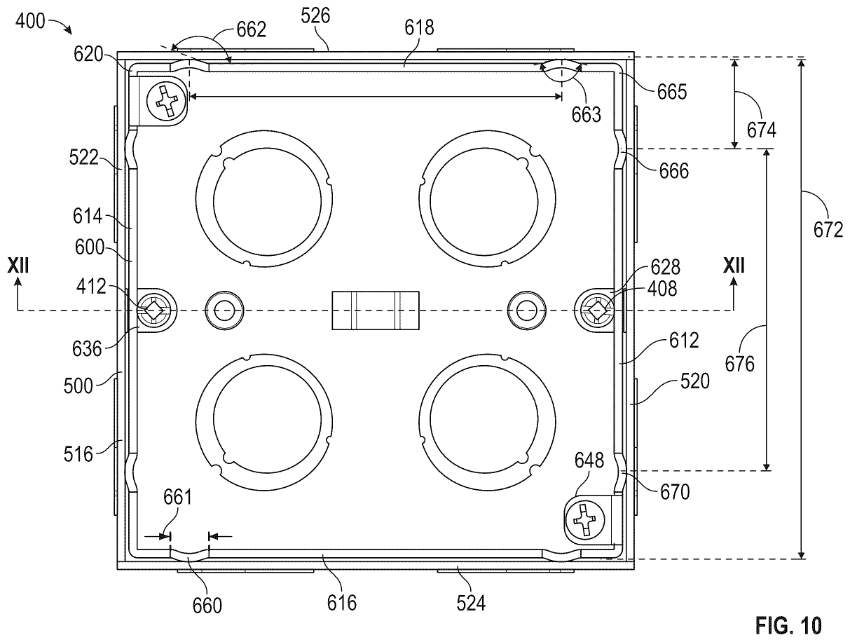

Referring to FIG. 10, in some embodiments, the guide protrusions 660 may be disposed adjacent a plurality of inner junctions (e.g., corners) that connect the inner sidewalls 604. As stated above, the first inner sidewall 612 and the second inner sidewall 614, may each include multiple instances of the guide protrusions 360 (e.g., symmetrically arranged). In some embodiments, guide protrusions may be spaced from a closest inner junction to avoid potential interference with mounting tabs that may be disposed proximate the inner junctions. For example, the first guide protrusion 666 may be disposed on the first inner sidewall 612 on an opposite side of the corresponding mounting tab 648 from the inner junction 620. In some examples, in particular, a bend line of a protrusion may be adjacent to a corresponding tab (e.g., as shown for the protrusion 666 and the mounting tab 648).

In some embodiments, the guide protrusions 660 disposed on the first inner sidewall 612 may be equally spaced from the first inner tab 628. In some embodiments, the guide protrusions 660 on the first inner sidewall 612 may be equally spaced from a center point of the first inner sidewall 612 (e.g., as far as possible without interfering with a mounting tab). Similarly, the second, third, and fourth inner sidewalls 614, 616, 618 may each include the guide protrusions 660 that may be equally spaced from a respective center point of the second, third, and fourth inner sidewalls 614, 616, 618. Further, as similarly discussed above, the guide protrusions 660 may be disposed symmetrically around the inner box 600.

In some examples, the guide protrusion width 661 may be at least about 0.3 inches, or at least about 0.4 inches. In some examples, the first guide protrusion angle 662 may be at least 145 degrees, at least about 150 degrees, or at least about 155 degrees. The second guide protrusion angle 663 may be at least about at least about 145 degrees, at least about 150 degrees, or at least about 155 degrees. Furthermore, the first distance 674 may be between about 1% and about 30%, or between about 5% and about 20% of the first sidewall length 672. Additionally, the second distance 376 may be at least about 50%, at least about 60%, or at least about 65% of the first sidewall length 672.

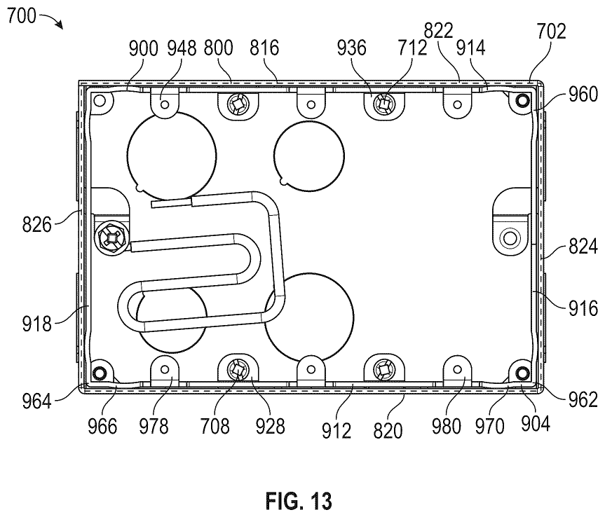

In some configurations, an electrical box assembly may include an alternate outer box and inner box configuration to accommodate other types of electrical components 702 (e.g., low voltage, mudrings, and other electrical devices, etc.). In this regard, for example, FIG. 13 illustrates another embodiment of an electrical box assembly 700. The electrical box assembly 700 of FIG. 13 may generally include similar features as the electrical box assembly 100 of FIGS. 1-8, including but not limited to an outer box 800, a plurality of outer sidewalls 816 (e.g., first, second, third, and fourth outer sidewalls 820, 822, 824, 826), a first and second outer tab (not shown) having a first and second outer aperture (not shown) respectively, a first and second tab fastener 708, 712, an inner box 900, a plurality of inner sidewalls 904 (e.g., first, second, third, and fourth inner sidewalls 912, 914, 916, 918) with guide protrusions 960, a first and second inner tab 928, 936 having first and second tab apertures (not shown) respectively, and one or more mounting tabs 948. Thus, discussion of the electrical box assembly 100 above also generally applies to similar components of the electrical box assembly 700 (and vice versa).

In some aspects, the electrical box assemblies 100 and 700 may differ. For example, the electrical box assembly 700 of FIG. 13 may include the outer box 800 and inner box 900 that have an elongated rectangular perimeter. As above, the first inner sidewall 912 may include the first inner tab 928. Furthermore, the second inner sidewall 914 may include the second inner tab 936, which may not be directly opposite the first inner tab 928.

Referring to FIG. 13, in some embodiments, some of the guide protrusions 960 may be disposed adjacent corresponding inner junctions that connect the inner sidewalls 904. Correspondingly, for example, bend lines of the various protrusions 960 can be arranged as generally discussed above.

As also discussed above, each of the inner sidewalls 904 may include a plurality of the guide protrusions 960. In some embodiments, a first guide protrusion 966 may be disposed between a first mounting tab 978 and the inner junction 964. In some embodiments, a second guide protrusion 970 may be disposed between a second mounting tab 980 and an inner junction 962 connecting the first inner sidewall 912 and the third inner sidewall 916. In some examples, the protrusions 960 can be spaced relative to adjustment tabs or mounting tabs as generally discussed above for other assemblies. In some examples, the protrusions can be arranged symmetrically, also as generally discussed above.

In the present example, the electrical box assembly 700 includes four outer tabs and four inner tabs, although a variety of other configurations are possible. In some embodiments, the various guide protrusions 960 may exhibit similar absolute or relative spacings (e.g., relative to other protrusions, junctions between side walls, mounting tabs, the outer box, etc.) as are discussed for other examples above.

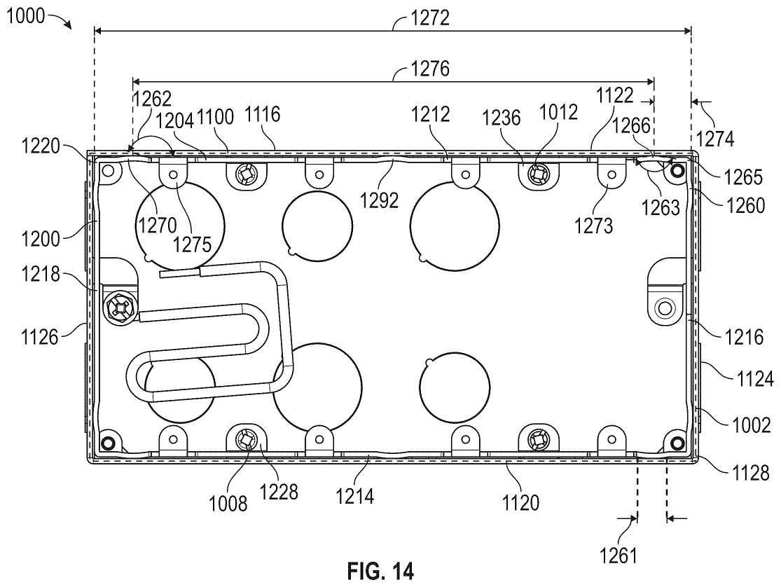

FIG. 14 illustrates another embodiment of an electrical box assembly 1000 with still another geometric configuration to accommodate different types of electrical components 1002 (e.g., low voltage, mudrings, and other electrical devices, etc.). The electrical box assembly 1000 of FIG. 14 may generally include similar features as the electrical box assembly 100 of FIGS. 1-8, including but not limited to an outer box 1100, a plurality of outer sidewalls 1116 (e.g., first, second, third, and fourth outer sidewalls 1120, 1122, 1124, 1126), outer junctions 1128, a first and second outer tab (not shown) having a first and second outer apertures (not shown) respectively, a first and second tab fastener 1008, 1012, an inner box 1200, a plurality of inner sidewalls 1204 (e.g., first, second, third, and fourth inner sidewalls 1212, 1214, 1216, 1218, the first sidewall 1212 having a first (full) sidewall length 1272), inner junctions 1220 with guide protrusions 1260, a first and second inner tab 1228, 1236 having first and second inner apertures (not shown) respectively. Furthermore, the inner box 1200 may include a plurality of guide protrusions 1260 each having a guide protrusion width 1261, a first guide protrusion angle 1262, and a second guide protrusion angle 1263, and the guide protrusions 1260 may include a first guide protrusion 1266 spaced from one of a first inner junction 1265 by a first distance 1274, and may further include a second guide protrusion 1270 spaced from the first guide protrusion 1266 by the second distance 1276. Thus, discussion of the electrical box assembly 100 above also generally applies to similar components of the electrical box assembly 1000 (and vice versa).

In some embodiments, the first inner sidewall 1212 and the third inner sidewall 1216 may include a differing number of the guide protrusions 1260. In the illustrated example, the first inner sidewall 1212 includes three of the guide protrusions 1260, and the third inner sidewall 1216 includes two of the guide protrusions 1260 (e.g., in each case arranged symmetrically on the relevant sidewall or relative to protrusions on an opposing sidewall). In some embodiments, the guide protrusions 1260 disposed on the first inner sidewall 1212 may be equally spaced. For example, a first distance between a first guide protrusion 1266 and a second guide protrusion 1270 may be the substantially equal to a second distance between the second guide protrusion 1270 and a third guide protrusion 1292. In some embodiments, the guide protrusions 1260 on the first inner sidewall 1212 may exhibit different spacing. In some embodiments, the various guide protrusions 1560 may exhibit similar absolute or relative spacings (e.g., relative to other protrusions, junctions between side walls, mounting tabs, the outer box, etc.) as are discussed for other examples above.

In some embodiments, the first guide protrusion 1266 may be disposed between a first mounting tab 1272 and the inner junction 1220 connecting the first inner sidewall 1212 and the fourth inner sidewall 1218. In some embodiments, the second guide protrusion 1270 may be disposed between a second mounting tab 1276 and the inner junction 1220 connecting the first inner sidewall 1212 and the second inner sidewall 1216. In some embodiments, one or more of the guide protrusions 1260 may be disposed in between the first mounting tab 1272 and the second mounting tab 1276.

In some examples, the guide protrusion width 1261 may be at least about 0.45 inches, or at least about 0.5 inches. In some examples, the first guide protrusion angle 1262 may be at least about 155 degrees, at least about 160 degrees, or at least about 165 degrees. The second guide protrusion angle 1263 may be at least about at least about 155 degrees, at least about 160 degrees, or at least about 165 degrees. Furthermore, the first distance 1274 may be between about 3% and about 15%, or between about 1% and about 18% of the first sidewall length 1272. Additionally, the second distance 1276 may be at least about 60%, or at least about 70%, or at least about 80% of the first sidewall length 1272.

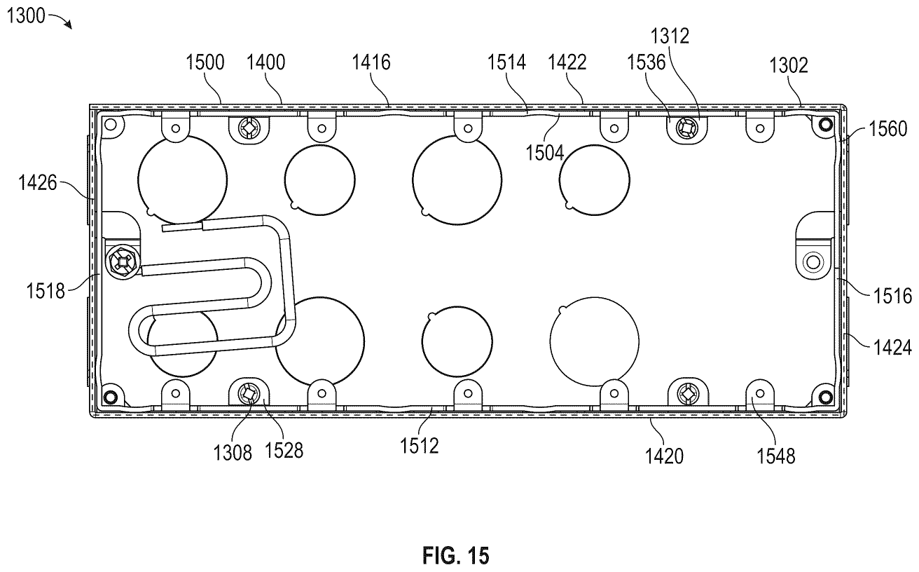

FIG. 15 illustrates another embodiment of an electrical box assembly 1300 to accommodate different types of electrical components 1302 (e.g., low voltage, mudrings, and other electrical devices, etc.). The electrical box assembly 1300 of FIG. 15 may generally include similar features as the electrical box assembly 100 of FIGS. 1-8, including but not limited to an outer box 1400, a plurality of outer sidewalls 1416 (e.g., first, second, third, and fourth outer sidewalls 1420, 1422, 1424, 1426), a first and second outer tab (not shown) having a first and second outer tab aperture (not shown) respectively, a first and second tab fastener 1308, 1312, an inner box 1500, a plurality of inner sidewalls 1504 (e.g., first, second, third, and fourth inner sidewalls 1512, 1514, 1516, 1518 with guide protrusions 1560, a first and second inner tab 1528, 1536 having first and second inner tab apertures (not shown) respectively, and one or more mounting tabs 1548. Thus, discussion of the electrical box assembly 100 above also generally applies to similar components of the electrical box assembly 1300 (and vice versa).

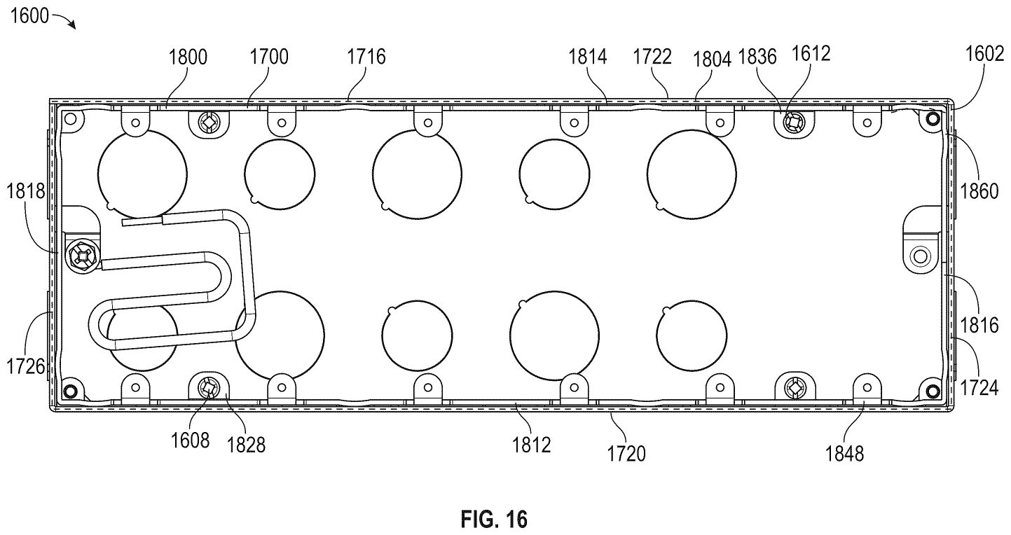

FIG. 16 illustrates another embodiment of an electrical box assembly 1600 to accommodate different types of electrical components 1602 (e.g., low voltage, mudrings, and other electrical devices, etc.). The electrical box assembly 1600 of FIG. 16 may generally include similar features as the electrical box assembly 100 of FIGS. 1-8, including but not limited to an outer box 1700, a plurality of outer sidewalls 1716 (e.g., first, second, third, and fourth outer sidewalls 1720, 1722, 1724, 1726), a first and second outer tab (not shown) having a first and second outer aperture (not shown) respectively, a first and second tab fastener 1608, 1612, an inner box 1800, a plurality of inner sidewalls 1804 (e.g., first, second, third, and fourth inner sidewalls 1812, 1814, 1816, 1818) with guide protrusions 1860, a first and second inner tab 1828, 1836 having first and second inner apertures (not shown), respectively, and one or more mounting tabs 1848. In the present example, the electrical box assembly 1300 includes four outer tabs and four inner tabs, although a variety of other configurations are possible. Thus, discussion of the electrical box assembly 100 above also generally applies to similar components of the electrical box assembly 1600 (and vice versa). In some embodiments, the various guide protrusions 1860 may exhibit similar absolute or relative spacings (e.g., relative to other protrusions, junctions between side walls, mounting tabs, the outer box, etc.) as are discussed for other examples above.

The discussion above is framed relative to particular electrical box assemblies and associated arrangements. However, those of skill in the art will recognize that this discussion implicitly also discloses various methods of adjustably mounting electrical boxes relative to support structures. Similarly, as also discussed above, the particular configurations of the boxes and other components expressly described and illustrated in the various embodiments are presented as examples only, and the concepts disclosed herein can be used to adjustably secure electrical boxes (or other components) relative to a variety of bracket configurations and support structures. Further, specific features discussed in detail relative to certain embodiments can be generally configured or used similarly with other embodiments, including relative to similar features on those embodiments or as substitutions or additions to those embodiments.

Thus, examples of the disclosed technology can provide improved systems for installing electrical box assemblies for suspending electrical components and fixtures. Some examples provide a height adjustable electrical box assembly that is inexpensive to manufacture while providing an improved mechanism for reducing vibration of the electrical wiring, electrical components, and other electrical fixtures after installation of the electrical box assembly.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Ranges as provide herein are inclusive of endpoints unless otherwise specified.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An adjustable-depth electrical box assembly, the assembly comprising:
an outer box including outer sidewalls that extend from a base end to an open end of the outer box, the outer sidewalls including a first outer sidewall, a second outer sidewall opposite the first outer sidewall, a third outer sidewall, and a fourth outer sidewall opposite the third outer sidewall;
an inner box including:
inner sidewalls extending between a first end and a second end of the inner box, including a first inner sidewall, a second inner sidewall opposite the first inner sidewall, a third inner sidewall, and a fourth inner sidewall opposite the third inner sidewall; and
guide protrusions extending outwardly from the inner sidewalls, including a first guide protrusion protruding from the first inner sidewall, a second guide protrusion protruding from the second inner sidewall, a third guide protrusion protruding from the third inner sidewall, and a fourth guide protrusion protruding from the fourth inner sidewall;
the outer sidewalls slidably receiving the inner box with the first guide protrusion contacting an inner side of the first outer sidewall, the second guide protrusion contacting an inner side of the second outer sidewall, the third guide protrusion contacting an inner side of the third outer sidewall, and the fourth guide protrusion contacting an inner side of the fourth outer sidewall to guide sliding movement of the inner box relative to the outer box.

2. The assembly of claim 1, wherein the first inner sidewall includes a first tab that receives a fastener to attach an electrical device to the inner box;
wherein the first inner sidewall includes a first plurality of guide protrusions, including the first guide protrusion; and
wherein the first guide protrusion is disposed farther than the first tab from a junction between the first inner sidewall and the third inner sidewall.

3. The assembly of claim 1, wherein the guide protrusions extend outwardly from the inner sidewalls by between 0.015 inches and 0.05 inches.

4. The assembly of claim 3, wherein the first guide protrusion extends from the first inner sidewall at a first protrusion end and a second protrusion end, and wherein a width of the first guide protrusion measured between the first protrusion end and the second protrusion end, along a width direction in parallel with the first inner sidewall, is at least 0.20 inches.

5. The assembly of claim 4, wherein a peak of the first protrusion is disposed between the first protrusion end and the second protrusion end and the peak contacts the first outer sidewall, a tangent axis extends tangentially from the first guide protrusion at a midpoint along the first protrusion between the first protrusion end and the peak, and an angle between the width direction and the tangent axis is at least 150 degrees.

6. The assembly of claim 1, wherein the first guide protrusion is disposed along the first inner sidewall, spaced from a junction between the first inner sidewall and the third inner sidewall by between about 1% and about 20% of a total length of the first inner sidewall.

7. The assembly of claim 6, wherein a distance between the first guide protrusion and a fifth guide protrusion protruding from the first inner sidewall is at least 40% of a total length of the first inner sidewall.

8. The assembly of claim 1, wherein the guide protrusions provide less than 0.050 inches of clearance between one of the inner sidewalls and the respective outer sidewall.

9. The assembly of claim 1, wherein the guide protrusions extend along the respective inner sidewall over substantially all of a distance between the first end and the second end. 10 An assembly for an adjustable-depth electrical box, the assembly comprising:
an outer box including outer sidewalls extending from a base end to an open end of the outer box;
an inner box slidably received into the outer box and including:
inner sidewalls extending between a first free edge and a second free edge of the inner box, including a first set of opposed inner sidewalls and a second set of opposed inner sidewalls; and
guide protrusions extending from the inner sidewalls to engage the outer sidewalls, the guide protrusions including at least one guide protrusion, respectively, on each inner sidewall of the first set of opposed inner sidewalls and on each inner sidewall of the second set of opposed inner sidewalls.

11. The assembly of claim 10, wherein a first inner sidewall of the inner sidewalls includes a first tab that receives a fastener that movably couples the inner box and the outer box;
wherein the first inner sidewall includes a first plurality of guide protrusions; and
wherein the first tab is disposed between a first guide protrusion of the first plurality of guide protrusions and a second guide protrusion of the first plurality of guide protrusions.

12. The assembly of claim 10, wherein a first guide protrusion extends from a first inner sidewall of the inner sidewalls at a first protrusion end and a second protrusion end, and includes a peak that contacts a first outer sidewall of the outer sidewalls; and
wherein a first tangent axis extends tangentially from the first guide protrusion at a midpoint along the first guide protrusion between the first protrusion end and the peak, and a second tangent axis extends tangentially from the first guide protrusion at a midpoint along the first guide protrusion between the second protrusion end and the peak; and
wherein an angle between the first tangent axis and the second tangent axis is at least 130 degrees.

13. The assembly of claim 12, wherein the first guide protrusion deflects from the first inner sidewall at the first protrusion end and at the second protrusion end, wherein a width of the first guide protrusion measured between the first protrusion end and the second protrusion end is at least 0.20 inches.

14. The assembly of claim 10, wherein each inner sidewall of the first and second sets of inner sidewalls includes at least two guide protrusions.

15. The assembly of claim 10, wherein the guide protrusions are the only points of direct contact between the inner sidewalls and the outer sidewalls.

16. The assembly of claim 10, wherein the inner box is configured to be coupled to a mudring.

17. A method of assembling an adjustable-depth electrical box, the method comprising:
aligning an inner box relative to an outer box so that guide protrusions on at least four inner sidewalls of the inner box are aligned to engage corresponding at least four outer sidewalls of the outer box;
inserting the inner box into the outer box to engage the guide protrusions along at least four outer sidewalls; and
with the guide protrusions engaged with the at least four outer sidewalls, adjusting a depth of the inner box relative to the outer box.

18. The method of claim 17, further comprising adjusting a position of the inner box relative to the outer box by rotating a fastener coupled to the inner box and the outer box.

19. The method of claim 18, wherein during the adjusting of the position of the inner box, the guide protrusions slidably engage the outer box as the only direct contact points between the outer box and inner box.

20. The method of claim 17, further comprising coupling one or more of an electrical device and a mudring to the inner box.
